(19) United States
(12) Patent Application Publication
(10) Pub. No.: US 2026/0099793 A1
(43) Pub. Date: Apr. 9, 2026

(54) MANAGING WORKFLOWS OF USER APPLICATIONS BASED ON ARTIFICIAL INTELLIGENCE

(71) Applicant: SK Hynix NAND Product Solutions Corp. (dba Solidigm), Rancho Cordova, CA (US)

(72) Inventors: Matt A. YURDANA, Portland, OR (US); Rita H. WOUHAYBI, Portland, OR (US)

(21) Appl. No.: 18/909,812

(22) Filed: Oct. 8, 2024

(51) Int. Cl. G06Q 10/0633; G06F 3/04842

(52) U.S. Cl. CPC G06Q 10/0633; G06F 3/04842

(57) ABSTRACT

Some embodiments are directed to systems and methods that generate and control workflows. In one aspect, a computer system includes one or more processors and memory. The computer system detects one or more user actions requesting context data associated with a workflow, retrieves the context data from the memory, and receives a user response associated with the context data. The computer system applies a context processing model to process the context data and generate model output data. The computer system generates a workflow controlling instruction based on the user response and the model output data. The computer system at least partially controls the workflow using the workflow controlling instruction.

### TECHNICAL FIELD

The present application generally relates to computer technology, and more particularly to, methods, systems, and non-transitory computer readable storage media for controlling workflows in user applications implemented on a cloud-based work platform and enhancing computational efficiency of a computer system.

### BACKGROUND

A workflow involving user accounts of a user application running on edge devices, integrated with a cloud-based work platform, operates by distributing tasks and processes across both local and cloud resources. Edge devices, which are closer to the end users or data sources, handle certain tasks locally, such as data collection, initial processing, or offline functionality, allowing for faster response times and reduced latency. The user application on these edge devices interacts with the cloud platform, where more resource-intensive processes like data synchronization, long-term storage, and advanced analytics are managed. The workflow allows for seamless integration of local and cloud-based operations, providing users with real-time capabilities even in environments with limited connectivity. Particularly, in many situations, the workflow is managed based on predefined business rules among different user accounts. Each user account is assigned particular roles and permissions, and actions within the application follow a set of rules that dictate how tasks are assigned, approved, or escalated. The rule-based structure provides consistency, and however, often faces challenges such as low efficiency and lack of flexibility. These predefined rules, while useful for standardizing processes, can be rigid and fail to adapt to the dynamic nature of business operations. Changes in user roles, evolving project requirements, or the need for real-time collaboration may require deviations from these rules, but the static nature of the predefined logic can slow down decision-making and task completion. Additionally, automating workflows based solely on fixed rules can lead to bottlenecks when exceptions or unforeseen situations arise, as manual intervention is typically needed to handle edge cases. This lack of adaptability hinders the overall agility of the platform and may result in inefficient resource allocation, task delays, and reduced user satisfaction.

### SUMMARY

In accordance with some embodiments of this application herein is a realization that, when a workflow for a user application involve many users includes multiple steps where human interactions and decision-making are required, or is applied in a highly volatile business environment, the numerous steps and human subjects involved can lead to lengthy pauses or interruptions due to time taken for users to make the necessary interactions and/or decisions. Accordingly, what is needed are systems and methods that improve the efficiency and flexibility of workflows by automated reviews or decision-making. Some embodiments of the present disclosure are directed to methods, systems, and non-transitory computer readable storage media for controlling workflows using artificial intelligence (AI). As disclosed, in some embodiments, a computer system is configured to monitor a user's actions for the purposes of completing a task. The user's actions provide context data that allows a context processing model to generate model output data to evaluate how the user completes the task, adjust subsequent operations following the user's actions, and/or suggest adjustment to previous operations that provides the context data. Stated another way, in some embodiments, the computer system is configured to adjust previous or subsequent stages of an associated workflow based on the model output data resulting from machine learning.

As disclosed, in some embodiments, the computer system observes (e.g., monitors or tracks) a workflow of a user application to understand different steps. In some embodiments, the computer system is configured to characterize human engagement and actions associated with slower portions of the workflow part or associated with errors in the workflow. In some embodiments, the computer system identifies the steps where a large language model (LLM) or a large visual model (LVM) can be automatically invoked by the computer system to generate content or suggest improvement on those steps of the workflow with no or litter user intervention. In some embodiments, the computer system controls the workflow by automating processes, such as filling forms or forwarding messages.

The disclosed systems and methods advantageously improve existing systems. For example, automating portions of a workflow makes it more reliable and less susceptible to errors. The disclosed system identifies portions of the workflow to automate by analyzing data flows and identifying the right AI techniques to make the processes more agile. In some embodiments, the workflow is changed to bypass or change orders of some operations, allowing computational resources (e.g., central processing units (CPUs), graphics processing units (GPUs), and tensor processing units (TPUs)), storage space (e.g., cache, volatile memory, or non-volatile memory), and communication bandwidths to be applied efficiently.

In one aspect, a method for controlling workflows is implemented at a computer system having one or more processors and memory. The method includes detecting one or more user actions requesting context data associated with a workflow. The method includes retrieving the context data from the memory and receiving a user response associated with the context data. The method includes applying a context processing model to process the context data and generate model output data. The method includes generating a workflow controlling instruction based on the user response and the model output data. The method also includes at least partially controlling the workflow using the workflow controlling instruction.

In some embodiments, generating the workflow controlling instruction includes comparing the user response and the model output data; adjusting at least one or more weights of the context processing model to match the model output data to the user response; determining that the at least one or more weights of the context processing model are associated with a prior portion of the workflow; and generating the workflow controlling instruction including a change to at least a controlling parameter of the prior portion of the workflow. The workflow controlling instruction is applied to update the prior portion of the workflow based on an adjustment of the one or more weights.

In some embodiments, generating the workflow controlling instruction includes comparing the user response and the model output data. In accordance with a determination that the user response does not match the model output data, based on the workflow controlling instruction, extending a current session of the workflow so as to request a supplemental user response associated with the context data, where one or more response hints are presented during the extended current session to guide the supplemental user response.

In some embodiments, generating the workflow controlling instruction includes comparing the user response and the model output data; and based on a comparison result, updating the workflow controlling instruction to add, delete, change an order, or modify a controlling parameter of, a subsequent session of the workflow, following the user response.

In some embodiments, the context processing model includes a large language model (LLM). Applying the context processing model includes generating a natural language query based on the context data; and obtaining the model output data that is generated by the LLM based on the natural language query.

In some embodiments, the context processing model includes a large visual model (LVM). Applying the context processing model includes applying the LVM to extract visual data from the context data; and obtaining the model output data by processing the visual data.

According to another aspect of the present application, a computer system includes one or more processors and memory. The memory stores instructions that, when executed by the one or more processors, cause the computer system to perform any of the methods for controlling workflows as disclosed herein.

According to another aspect of the present application, a non-transitory computer readable storage medium stores instructions configured for execution by a computer system that includes one or more processors and memory. The instructions, when executed by the one or more processors, cause the computer system to perform any of the methods for controlling workflows as disclosed herein.

Note that the various embodiments described above can be combined with any other embodiments described herein. The features and advantages described in the specification are not all inclusive and, in particular, many additional features and advantages will be apparent to one of ordinary skill in the art in view of the drawings, specification, and claims. Moreover, it should be noted that the language used in the specification has been principally selected for readability and instructional purposes and may not have been selected to delineate or circumscribe the inventive subject matter.

### BRIEF DESCRIPTION OF THE DRAWINGS

The accompanying drawings, which are included to provide a further understanding of the embodiments, are incorporated herein, constitute a part of the specification, illustrate the described embodiments, and, together with the description, serve to explain the underlying principles.

FIG. 1 depicts a representative smart work environment, in accordance with some implementations.

FIG. 2 is an example operating environment in which a smart device interacts with a client device or a server system, in accordance with some implementations.

FIG. 3 is a block diagram illustrating a computer system of a smart work environment, in accordance with some implementations.

FIG. 4 is a block diagram of a machine learning system for training and applying data processing models using machine learning, in accordance with some embodiments.

FIG. 5A is a structural diagram of an example neural network applied to process work data in a data processing model, in accordance with some embodiments.

FIG. 5B is an example node in the neural network, in accordance with some embodiments.

FIG. 6A is an exemplary workflow associated with a warehousing application, in accordance with some embodiments.

FIG. 6B is an example table describing a plurality of aspects (e.g., timeline, feature events, and context data associated with events, actions, or interactions) of the workflow sown in FIG. 6A, in accordance with some embodiments.

FIG. 6C is a flow diagram of an example workflow management process for managing a workflow, in accordance with some embodiments.

FIG. 7 is a block diagram of an example workflow control module for controlling a workflow in a user application, in accordance with some embodiments.

FIGS. 8A to 8C provide a flowchart of an example process for controlling workflows, in accordance with some embodiments.

Like reference numerals refer to corresponding parts throughout the several views of the drawings.

### DETAILED DESCRIPTION

Reference will now be made in detail to specific embodiments, examples of which are illustrated in the accompanying drawings. In the following detailed description, numerous non-limiting specific details are set forth in order to assist in understanding the subject matter presented herein. But it will be apparent to one of ordinary skill in the art that various alternatives may be used without departing from the scope of the claims and the subject matter may be practiced without these specific details. For example, it will be apparent to one of ordinary skill in the art that the subject matter presented herein can be implemented on many types of electronic devices with digital video capabilities.

Some implementations of the present disclosure are directed to managing a workflow implemented on a computer system providing computational, storage, and communication resources. The computer system detects one or more user actions requesting context data associated with a workflow, retrieves the context data from the memory (e.g., based on user history or a workflow history), and receives a user response (e.g., a user interaction or user action) associated with the context data. A context processing model is applied to process the context data and generate model output data. A workflow controlling instruction is generated based on the user response. The computer system at least partially controls the workflow using the workflow controlling instruction.

In some embodiments, the workflow is implemented by an AI-based user application that has a client-side module deployed at scale on edge devices. Edge devices are hardware devices that sit at an edge of a network, closer to the source of data or end users, and communicatively coupled to a server of a centralized data center or cloud environment. Common examples of edge devices include sensors, smartphones, IoT (Internet of Things) devices, routers, smart cameras, industrial machines, and even wearables like smartwatches. In some embodiments, a workflow includes a series of tasks, stages, or steps. In some embodiments, a workflow includes multiple sessions (or instances), where each session corresponds to a respective execution of the workflow.

In some embodiments, the context data includes previous data associated with the workflow. In some embodiments, the context data includes previous user interactions or actions associated with the workflow. In some embodiments, the context data includes previous decisions associated with the workflow. In some embodiments, the workflow is implemented at least partially at a venue. In some embodiments, the computer system obtains sensor data provided by a plurality of sensors installed at the venue, and generates a stream of venue data associated with the venue based on the sensor data. In some embodiments, the computer system detects an occurrence of an event (e.g., a predefined event, a signature event, or an event that is of significance) based on the stream of venue data. In some embodiments, the computer system generates an event processing message requesting the user response to the event, wherein the context data includes a subset of venue data associated with the event. In some embodiments, the workflow includes multiple steps that are performed by multiple users. In some embodiments, the workflow includes handoffs across different users and/or different devices. In some embodiments, the computer system generates the context data associated with the workflow while one or more stages of the workflow are being implemented. In some embodiments, the context data include one or more of: image or video data captured by a camera, statistical analysis data, trend data, an information list, a natural language input, a user interaction with a user interface associated with the workflow, a text message and an audio message. In some embodiments, the user interaction includes user selection of at least a region of an image that is displayed on the user interface. The computer system applies a context processing model to process the context data and generate model output data. In some embodiments, prior to applying the context processing model to process the context data, the computer system trains a machine learning model according to a corpus of training data that tracks user responses (or user interactions) to a first set of workflows. In some embodiments, the training data can include gaze tracking, click tracking, text entered, or any other engagement and input controlled by the user.

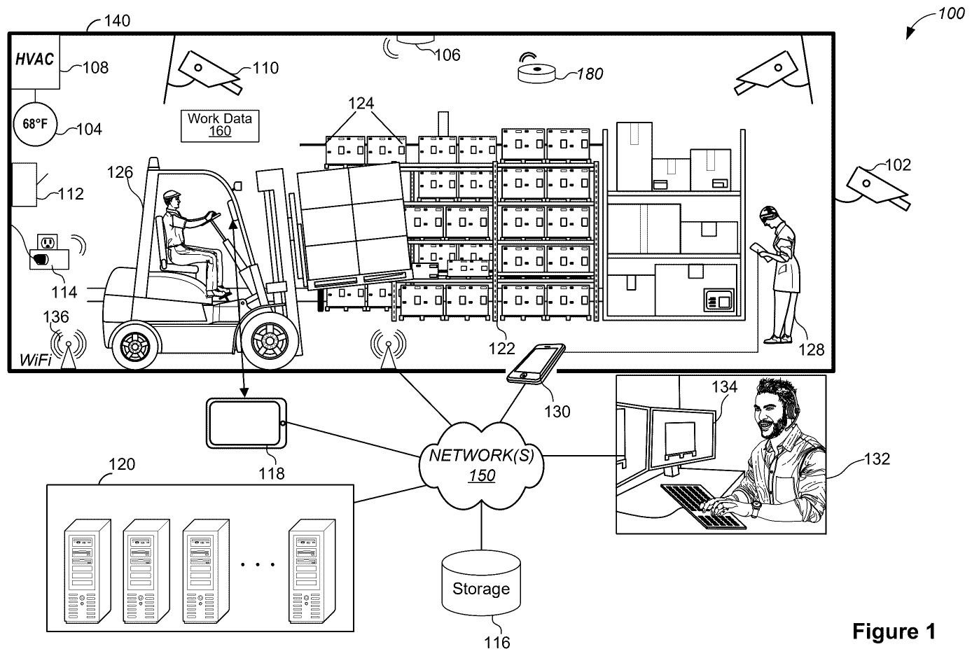

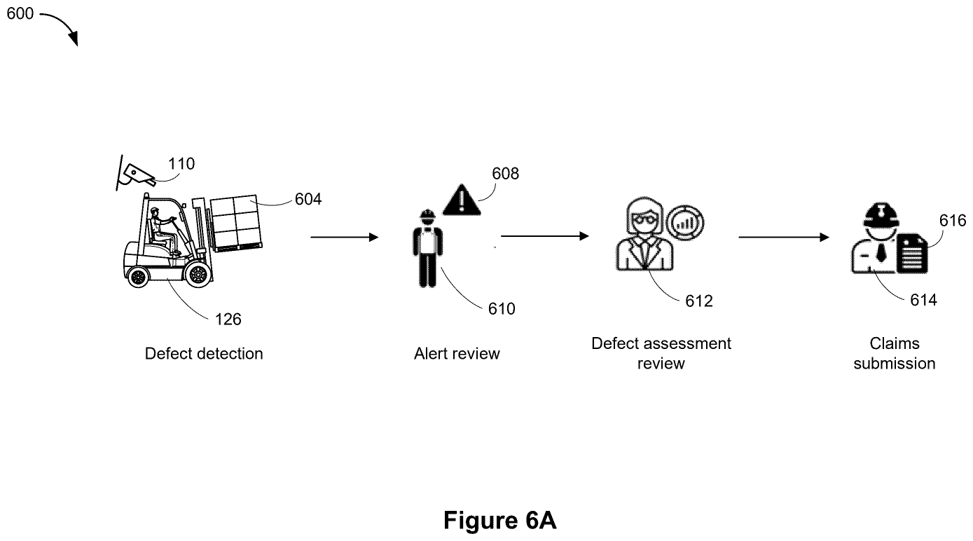

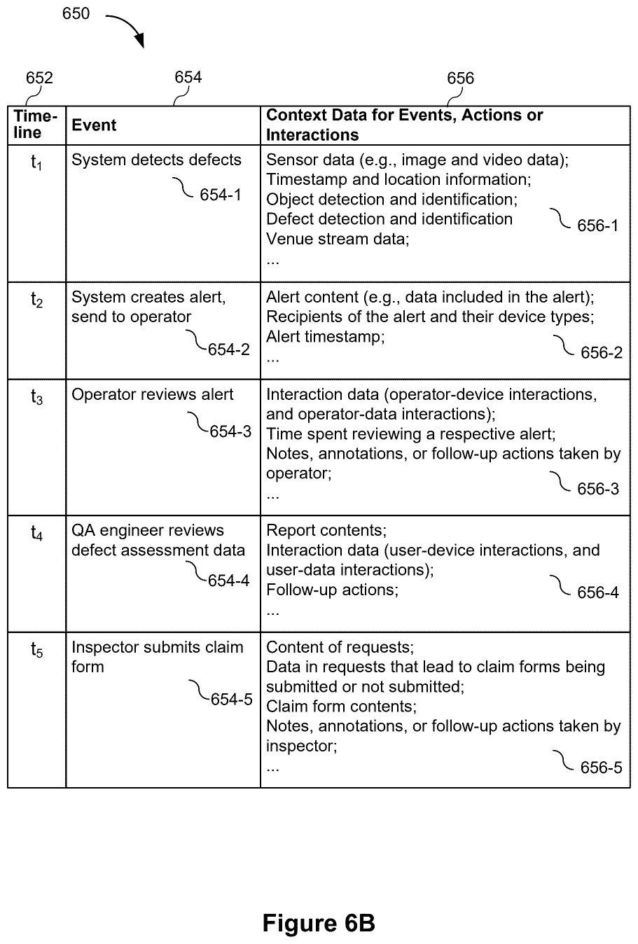

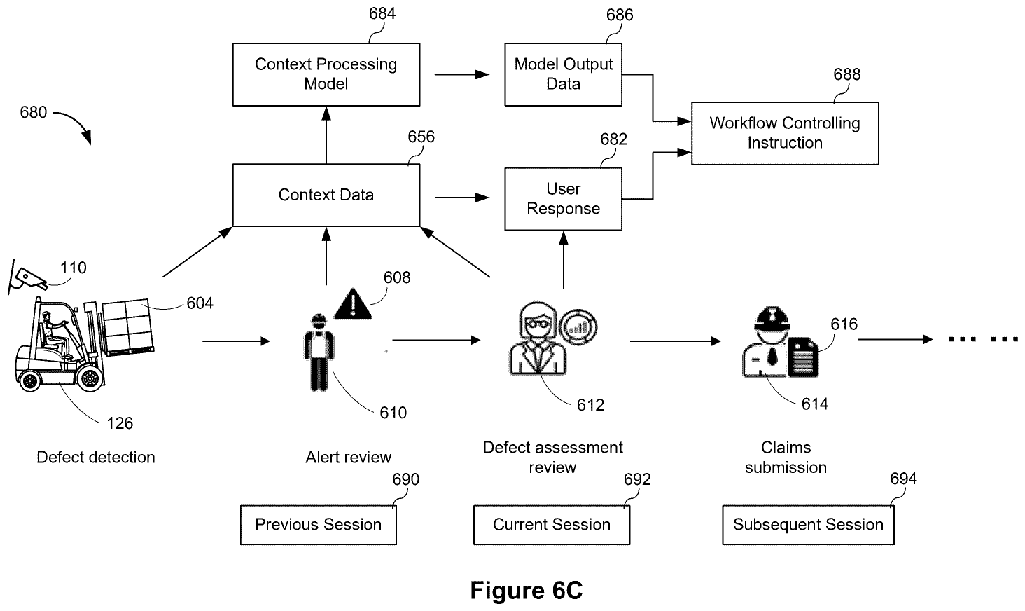

FIG. 1-5B provide background exemplary sensor device networks and capabilities (e.g., machine learning based data processing capabilities) described herein, which are helpful in understanding the details of the embodiments described from FIG. 6 onward.

FIG. 1 depicts a representative smart work environment 100 in accordance with some implementations. The smart work environment 100 includes a structure 140, which may be used as a warehouse, factory, construction site, farm, laboratory, office space, retail store, hospital, and the like. For example, the structure 140 may be used as a distribution center, an e-commerce fulfillment center, an automobile assembly plant, an electronics manufacturing facility, a supermarket, or a retailer store. It will be appreciated that the structure 140 has an open floor plan, high ceilings, and support structures (e.g. columns or beams) and may include different functional areas designed for efficiency, safety, and scalability. Further, the smart work environment 100 may control and/or be coupled to devices outside of the actual structure 140. Indeed, several devices in the smart work environment 100 need not be physically within the structure 140. For example, a surveillance camera 102 may be located outside of the structure 140.

The depicted structure 140 may include a plurality of areas (e.g., storage areas, work areas) that may not be physically separated by walls. The depicted structure 140 may also include rooms (not shown) that are separated from the plurality of areas by walls.

Devices may be mounted on, integrated with, and/or supported by a wall, a floor, a ceiling, or a support structure of the structure 140. Alternatively, devices may be mounted on, integrated with, and/or supported by an object (e.g., a shelf 122, a forklift 126) fixed or moveable in the structure 140.

In some implementations, the smart work environment 100 includes a plurality of devices, including intelligent, multi-sensing, network-connected devices, that integrate seamlessly with each other in a network 150 and/or with a central server system 120 or a cloud-computing system to provide a variety of useful smart work functions. The smart work environment 100 may include one or more surveillance cameras 102, one or more intelligent, multi-sensing, network-connected thermostats 104 (“smart thermostats”) and one or more intelligent, network-connected, multi-sensing hazard detection units 106 (“smart hazard detectors”). In some implementations, the smart thermostat 104 detects ambient climate characteristics (e.g., temperature and/or humidity) and controls an HVAC system 108 accordingly. The smart hazard detector 106 may detect the presence of a hazardous substance or a substance indicative of a hazardous substance (e.g., smoke, fire, and/or carbon monoxide). The surveillance cameras 102 may detect a person's or a vehicle's approach to or departure from the structure 140, identify and/or report any abnormal incidents, and/or control settings on a security system (e.g., to activate or deactivate the security system).

In some implementations, the smart work environment 100 includes one or more intelligent, multi-sensing, network-connected wall switches 112 (“smart wall switches”), along with one or more intelligent, multi-sensing, network-connected wall plug interfaces 114 (“smart wall plugs”). The smart wall switches 112 may detect ambient lighting conditions, detect room-occupancy states, and control a power and/or dim state of one or more lights. In some instances, smart wall switches 112 may also control a power state or speed of a fan, such as a ceiling fan. The smart wall plugs 114 may detect occupancy of a room or enclosure and control supply of power to one or more wall plugs (e.g., such that power is not supplied to the plug if nobody is present in the structure 140).

In some implementations, the smart work environment 100 includes a plurality of network-connected cameras 110 that are configured to provide video monitoring and security inside the structure 140. For example, the structure 140 is used as a warehouse, which is a bustling hub of activity, with neatly organized shelves 122 stretching high to accommodate an extensive inventory of product boxes 124. Each shelf 122 is carefully labeled and arranged to maximize space and ensure efficient access to goods. A forklift 126 may navigate the wide aisles with precision, lifting and moving boxes 124 from one location to another with a steady hum of its engine. The forklift 126 may include a computer device 118 for obtaining and updating information of the boxes 124 (e.g., box locations, weights, handling details). A worker 128 may check the stock levels on a handheld device 130, verifying the quantities and ensuring that inventory records match the physical stock. The air is filled with the sounds of the forklift's beeping and the occasional rustle of boxes as the warehouse maintains a routine of receiving, storing, and preparing products for distribution. A plurality of cameras 110 are distributed at different locations in the structure 140, and configured to capture static images or video clips monitoring activities of the forklift 126 and the worker 128.

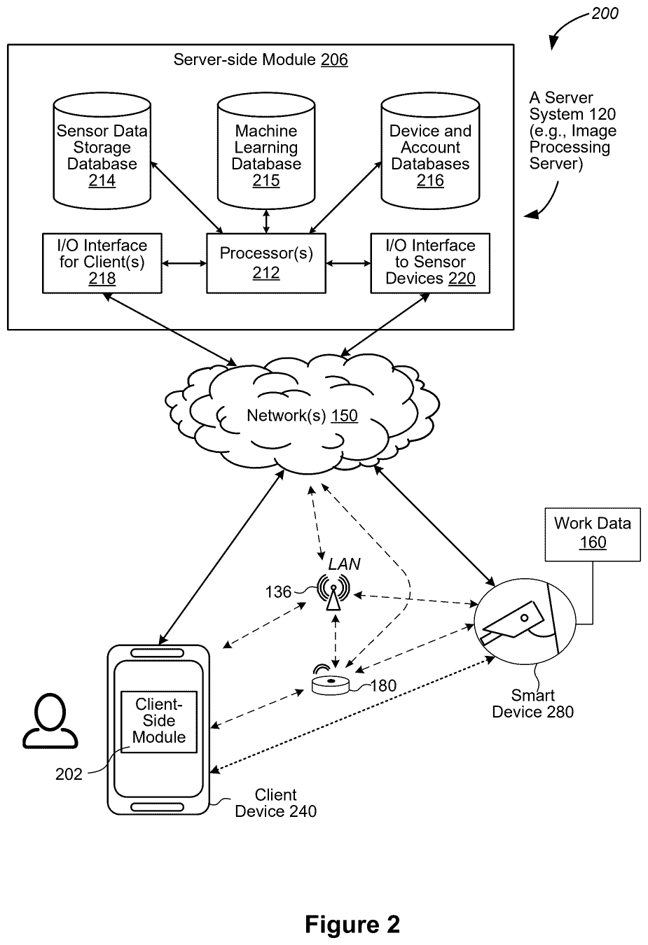

The devices 102-114 (e.g., collectively called smart devices 280 in FIG. 2) are examples of sensors and actuators that are disposed in the smart work environment 100 for collecting work data 160 (e.g., image data captured by cameras 110, temperature data captured by the smart thermostat 104). In some embodiments now shown, a variety of smart devices 280 are used to optimize efficiency and ensure smooth operations in the smart work environment 100. For example, radio frequency identification (RFID) sensors are employed to track products throughout the structure 140, ensuring that items are accurately located and inventoried. Proximity sensors may help robots and autonomous vehicles navigate safely by detecting obstacles and other machines. Infrared and optical sensors are used for barcode scanning, enabling quick identification of products. Additionally, pressure and weight sensors ensure that items are handled carefully and that shipping weights are accurate. Additional environmental sensors monitor conditions such as humidity to protect sensitive products. These technologies work together to create a highly automated and efficient smart work environment 100.

By virtue of network connectivity, one or more of the smart devices 280 may further allow a user to interact with the devices even if a user 132 is not proximate to the devices For example, the user 132 may communicate with a device using a computer device 134 (e.g., a desktop computer, laptop computer, a tablet computer, or other portable electronic device (e.g., a smartphone)). A webpage or application may be configured to receive communications from the user 132 and control the smart devices 280 based on the communications and/or to present information about the device's operation to the user 132. For example, the user 132 may view a current set point temperature for the smart thermostat 104 and adjust it using the computer device 134. The user 132 may review signature events captured by the camera 110 or adjust settings of the camera 110 using the computer device 134. The user 132 may be physically located within or outside the structure 140 during this remote communication.

As discussed above, users may control the smart thermostat 104 and other smart devices in the smart work environment 100 using a network-connected computer device 134. In some examples, a plurality of employees of a business entity associated with the structure 140 may register their devices 134 with the smart work environment 100. Such registration may be made at a central server 120 to authenticate the employees and/or the devices 134 as being associated with the structure 140 and to give permission to the employees to use the devices 134 to access the smart devices 280 in the structure 140.

Employees may use their registered devices 134 to remotely control the smart devices 280 of the structure 140, e.g., when an employee is at work, on vacation, or at a separate office location. The employee may also use a registered device 134 (e.g., handheld device 130) to control the smart devices 280 when the employee is actually located inside the structure 140, such as when the employee is checking stocking in the warehouse.

In some implementations, in addition to containing processing and sensing capabilities, the devices 102, 104, 106, 108, 110, 112, and/or 114 (“the smart devices”) are capable of data communications and information sharing with other smart devices, a central server or cloud-computing system, and/or other devices that are network-connected. The required data communications may be carried out using any of a variety of custom or standard wireless protocols (e.g., IEEE 802.15.4, Wi-Fi, ZigBee, 6LoWPAN, Thread, Z-Wave, Bluetooth Smart, ISA100.11a, WirelessHART, or MiWi) and/or any of a variety of custom or standard wired protocols (e.g., CAT6 Ethernet or HomePlug), or any other suitable communication protocol.

In some implementations, the smart devices 280 serve as wireless or wired repeaters. For example, a first one of the smart devices communicates with a second one of the smart devices via a wireless router. The smart devices may further communicate with each other via a connection to one or more networks 150 such as the Internet. Through the one or more networks 150, the smart devices may communicate with a smart work server system 120 (also called a central server system and/or a cloud-computing system herein). In some implementations, the smart work server system 120 may include multiple server systems, each dedicated to data processing associated with a respective subset of the smart devices (e.g., a video server system may be dedicated to data processing associated with camera(s) 110). The smart work server system 120 may be associated with a manufacturer, support entity, or service provider associated with the smart devices 280. In some implementations, the smart work environment 100 relies on a dedicated hub device 180 to manage smart devices 280 located within the smart work environment 100, and a hub device server system associated with the hub device 180 serves as the server system 120.

In some implementations, a user is able to contact customer support using a smart device itself rather than needing to use other communication means, such as a telephone or Internet-connected computer. In some implementations, software updates are automatically sent from the smart work server system 120 to smart devices 280 (e.g., when available, when purchased, or at routine intervals). In some embodiments, the smart work environment 100 further includes a storage 116 for storing data related to the servers 120, smart devices 280, client devices 118, 130, and 134 (e.g., collectively called client device 240 in FIG. 2), and applications executed on the client devices. In some embodiments, the storage 116 includes a plurality of SSDs.

FIG. 2 is an example operating environment 100 in which a smart device 280 (e.g., cameras 110) interacts with a client device 240 (e.g., devices 118, 130, and 134 in FIG. 1) or a server system 120 (e.g., an image processing server), in accordance with some implementations. In the operating environment 200, the server system 120 provides data processing for monitoring and facilitating review of object location/motion associated with imaging device data streams (e.g., raw or processed work data 160) captured by multiple cameras 110 disposed in the structure 140. As shown in FIG. 2, the server system 120 may receive raw or processed work data 160 from smart devices 280 (standalone or integrated) located at various physical locations in the smart work environments 100. Each smart device 280 may be bound to one or more reviewer accounts, and the server system 120 may further process the received work data 160 to obtain information associated with the smart device 280 and the corresponding reviewer accounts. For a camera 110, the obtained information could be object locations, object movements, user gestures, and depth mapping. In some implementations, the server system 120 provides the information to client devices 240 associated with the reviewer accounts. In some implementations, the server system 120 uses the information to control a smart device 280 linked to the reviewer accounts. In some implementations, the server system 120 is a dedicated image processing server that provides data processing services to cameras 110 and client devices 240 independently of other services provided by the server system 120.

In some implementations, each of the smart devices 280 captures work data 160 using signal detectors and sends the captured work data 160 to the server system 120 substantially in real time. In some implementations, each of the smart devices 280 includes a controller device (e.g., a smart device in which a camera 110 is integrated) that serves as an intermediary between the smart device 280 and the server system 120. The controller device receives the work data 160 from the one or more smart devices 280, optionally performs some preliminary processing on the work data 160, and sends the processed work data 160 to the server system 120 on behalf of the one or more smart devices 280 substantially in real time. In some implementations, each smart device 280 has its own on-board processing capabilities to perform some preliminary processing on the captured work data 160 before sending the processed work data 160 (along with metadata obtained through the preliminary processing) to the controller device and/or the server system 120. In some implementations, the client device 240 located in the smart work environment 100 functions as the controller device to at least partially process the captured work data 160.

In accordance with some implementations, each of the client devices 240 includes a client-side module 202. The client-side module 202 communicates with a server-side module 206 executed on the server system 120 through the one or more networks 150. The client-side module 202 provides client-side functionality for information monitoring, review processing, and communication with the server-side module 206. The server-side module 206 provides server-side functionality for event monitoring and review processing for any number of client-side modules 202, each residing on a respective client device 240. The server-side module 206 also provides server-side functionality for response processing and device control for any number of the smart devices 280.

In some implementations, the server-side module 206 includes one or more processors 212, a sensor data database 214, machine learning database 215, device and account databases 216, an I/O interface 218 to one or more client devices, and an I/O interface 220 to one or more smart devices 280. The I/O interface 218 to one or more clients facilitates the client-facing input and output processing for the server-side module 206. The device and account databases 216 store a plurality of profiles for reviewer accounts registered with the server system 120. A user profile includes account credentials for each reviewer account, and identifies one or more smart devices 280 linked to the reviewer account. In some implementations, the user profile of each reviewer account includes information related to capabilities, device characteristics, and lookup tables for the smart devices 280 linked to the reviewer account. The I/O interface 220 to one or more imaging devices facilitates communications with one or more smart devices 280 (standalone or integrated). The sensor data storage database 214 stores raw or processed work data 160 received from the smart devices 280 and associated information, as well as various types of metadata, such as device characteristics of signal emitters and detectors, lookup tables, modulation signals, and sampling rates. In some implementations, this data is used for generating additional information associated with each reviewer account. The machine learning database 215 stores data used by the server 120, the smart devices 280, or the client devices 240 to process the work data 160 collected by the smart devices 280 based on machine learning. For example, machine learning based data processing models and associated training data are stored in the machine learning database 215.

Client devices 240 include handheld computers, wearable computing devices, personal digital assistants (PDAs), tablet computers, laptop computers, desktop computers, cellular telephones, smart phones, enhanced general packet radio service (EGPRS) mobile phones, media players, navigation devices, game consoles, televisions, remote controls, point-of-sale (POS) terminals, vehicle-mounted computers, ebook readers, or a combination of any two or more of these data processing devices or other data processing devices. Examples of the one or more networks 150 include local area networks (LANs) and wide area networks (WANs) such as the Internet. In some implementations, the one or more networks 150 are implemented using any known network protocol, including various wired or wireless protocols, such as Ethernet, Universal Serial Bus (USB), FIREWIRE, Long Term Evolution (LTE), Global System for Mobile Communications (GSM), Enhanced Data GSM Environment (EDGE), code division multiple access (CDMA), time division multiple access (TDMA), Bluetooth, Wi-Fi, voice over Internet Protocol (VoIP), Wi-MAX, or any other suitable communication protocol.

In some implementations, the server system 120 is implemented on one or more standalone data processing devices or a distributed network of computers. In some implementations, the server system 120 employs various virtual devices and/or services of third party service providers (e.g., third-party cloud service providers) to provide the underlying computing resources and/or infrastructure resources of the server system 120. In some implementations, the server system 120 includes handheld computers, tablet computers, laptop computers, desktop computers, or a combination of any two or more of these data processing devices or other data processing devices.

The server-client environment 200 shown in FIG. 2 includes both a client-side portion (e.g., the client-side module 202) and a server-side portion (e.g., the server-side module 206). The division of functionality between the client and server portions of operating environment 200 can vary in different implementations. Similarly, the division of functionality between the smart devices 280 and the server system 120 can vary in different implementations. In some implementations, the client-side module 202 is a thin-client that provides only user-facing input and output processing functions, and delegates other data processing functionality to a backend server (e.g., the server system 120). In some implementations, a smart device 280 is a simple data capturing device that continuously captures and streams work data 160 to the server system 120, with limited local preliminary processing of the data. Although many aspects of the present technology are described from the perspective of a computer system (e.g., system 300) as a whole, the corresponding actions performed by the client device 240 and/or the server system 120 would be apparent to those of skill in the art. Some aspects of the present technology may be described from the perspective of the client device or the server system, and the corresponding actions performed by the server system would be apparent to those of skill in the art. Furthermore, some aspects of the present technology may be performed by the server system 120, the client device 240, and the smart device 280 cooperatively.

It should be understood that the operating environment 200 that involves the server system 120, the client device 240, and the smart device 240 is merely an example. Many aspects of operating environment 200 are generally applicable in other operating environments in which a server system provides data processing for monitoring and facilitating review of data captured by other types of electronic devices.

The smart devices, the client devices, and the server system communicate with each other using the one or more communication networks 150. In an example smart work environment 100, two or more devices (e.g., the network interface device 136, the hub device 180, the client devices 240, and the smart devices 204) are located in close proximity to each other, such that they can be communicatively coupled in the same sub-network via wired connections, a WLAN, or a Bluetooth Personal Area Network (PAN). The Bluetooth PAN is optionally established based on classical Bluetooth technology or Bluetooth Low Energy (BLE) technology. In some implementations, each of the hub device 180, the client device 240, and the smart devices 204 are communicatively coupled to the networks 150 via the network interface device 136.

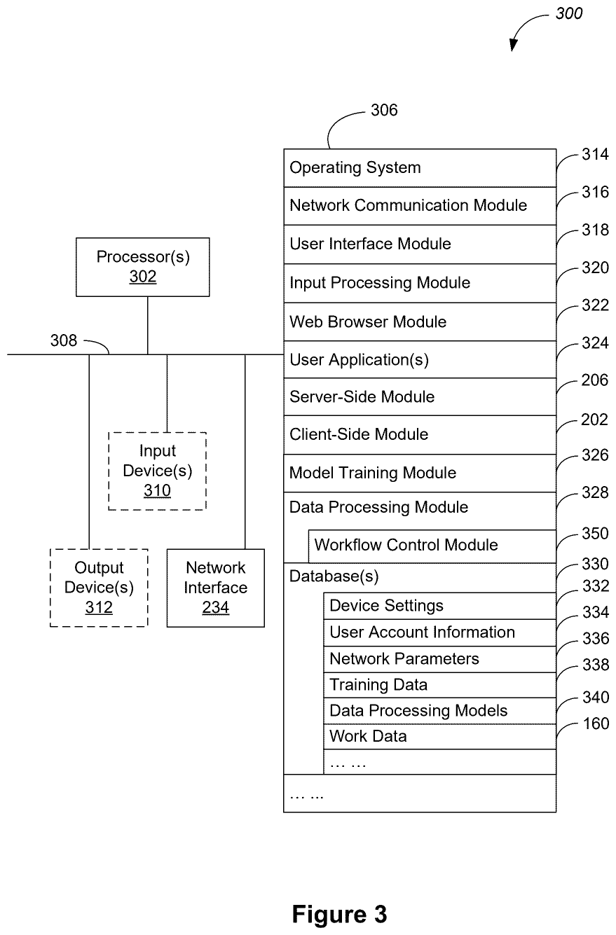

FIG. 3 is a block diagram illustrating a computer system 300 of a smart work environment 100 in accordance with some implementations. The computer system 300 includes a server 120, a client device 240 (e.g., computer device 118, 130, or 134 in FIG. 1), a smart device 280 (e.g., devices 102-114 in FIG. 1), a storage 116, or a combination thereof, and is configured to enable the smart work environment 100. The computer system 300 includes one or more processing units (CPUs) 302, one or more network interfaces 304, memory 306, and one or more communication buses 308 for interconnecting these components (sometimes called a chipset). In some implementations, the computer system 300 includes one or more input devices 310, which facilitate user input, such as a keyboard, a mouse, a voice-command input unit or microphone, a touch screen display, a touch-sensitive input pad, a gesture capturing camera, or other input buttons or controls. In some implementations, the computer system 300 uses a microphone and voice recognition or a camera and gesture recognition to supplement or replace the keyboard. In some implementations, the computer system 300 includes one or more cameras, scanners, or photo sensor units for capturing images. In some implementations, the computer system 300 includes one or more output devices 312, which enable presentation of user interfaces and display content, including one or more speakers and/or one or more visual displays.

The memory 306 includes high-speed random access memory, such as DRAM, SRAM, DDR RAM, or other random access solid state memory devices. In some implementations, the memory 306 includes non-volatile memory, such as one or more magnetic disk storage devices, one or more optical disk storage devices, one or more flash memory devices, or one or more other non-volatile solid state storage devices. In some implementations, the memory 306 includes one or more storage devices remotely located from the processing units 302. The memory 306, or alternatively the non-volatile memory within the memory 306, includes a non-transitory computer readable storage medium. In some implementations, the memory 306, or the non-transitory computer readable storage medium of the memory 306, stores the following programs, modules, and data structures, or a subset or superset thereof:
an operating system 314, which includes procedures for handling various basic system services and for performing hardware dependent tasks;
a network communication module 316, which connects the computer system 300 to other devices (e.g., various servers in the server system 120, a client device, or a smart device) via one or more network interfaces 304 (wired or wireless) and one or more networks 150, such as the Internet, other wide area networks, local area networks, metropolitan area networks, and so on;
a user interface module 318, which enables presentation of information (e.g., a graphical user interface for presenting applications, widgets, websites and web pages thereof, and/or games, audio and/or video content) at a client device 118, 130, and 134;
an input processing module 320 for detecting one or more user inputs or interactions from one of the one or more input devices 310 and interpreting the detected input or interaction;
a web browser module 322 for navigating, requesting (e.g., via HTTP), and displaying websites and web pages thereof, including a web interface for logging into a user account associated with a client device 140 or another electronic device, controlling the client or electronic device if associated with the user account, and editing and reviewing settings and data that are associated with the user account;
one or more user applications 324 for execution by the servers 120 (e.g., smart work applications, and/or other web or non-web based applications);
a server-side module 206, which communicates both with smart work environments 100 and with client-side modules 202 and includes a plurality of individual programs, procedures, modules, and/or objects for performing a variety of functions;
a client-side module 202, which communicates with the server-side module 206 in the smart work environment 100 and includes a plurality of individual programs, procedures, modules, and/or objects for performing a variety of functions;
model training module 326 for receiving training data and establishing one or more data processing models 340 for processing work data 160 (e.g., video, image, audio, or textual data) collected by the smart devices 280;
a data processing module 328 for processing work data 160 using data processing models 340, thereby identifying information contained in the work data 160, matching the work data 160 with other data, categorizing the work data 160, or synthesizing related work data 160; and
one or more databases 330 for storing at least data including one or more of:
   device settings 332 including common device settings (e.g., service tier, device model, storage capacity, processing capabilities, communication capabilities, etc.) of the one or more servers 120, client devices, or smart devices;
   user account information 334 for the one or more user applications 324, e.g., user names, security questions, account history data, user preferences, and predefined account settings;
   network parameters 336 for the one or more communication networks 150, e.g., IP address, subnet mask, default gateway, DNS server and host name;
   training data 338 for training one or more data processing models 340;
   data processing model(s) 340 for processing work data 160 (e.g., video, image, audio, or textual data) using deep learning techniques;
   work data 160 and associated results, where the work data 160 is processed using the data processing models 340 remotely at the server 120 or locally at the client device 240 to provide the associated results to be presented on the client devices or further processed.

In some implementations, the server-side module 106 acts as a control layer or API to the underlying functionality. In some implementations, the server-side module includes one or more of an emitter modulation module, a signal detection module, an object detection module, a location module, a movement module, a depth mapping module, and/or a gesture determination module for a smart device 280. Some implementations implement all of these features at a server system 120, some implementations implement all of these features at the camera 110, and some implementations distribute the functionality between the server 120 and the imaging device (e.g., based on efficiency considerations). In some implementations, the server-side module 206 includes a response processing module, which receives either raw unprocessed signals received at an camera 110 or signals that have been preprocessed by a local response processing module at the camera 110. The response processing module prepares the work data 160 (e.g., time of flight detection data) for use by the location module, the movement module, the depth mapping, and/or the gesture determination module. The server-side module 206 also includes an account administration module, which enables users to set up smart work environments 100 and to identify the smart devices 204 associated with the smart work environment 100.

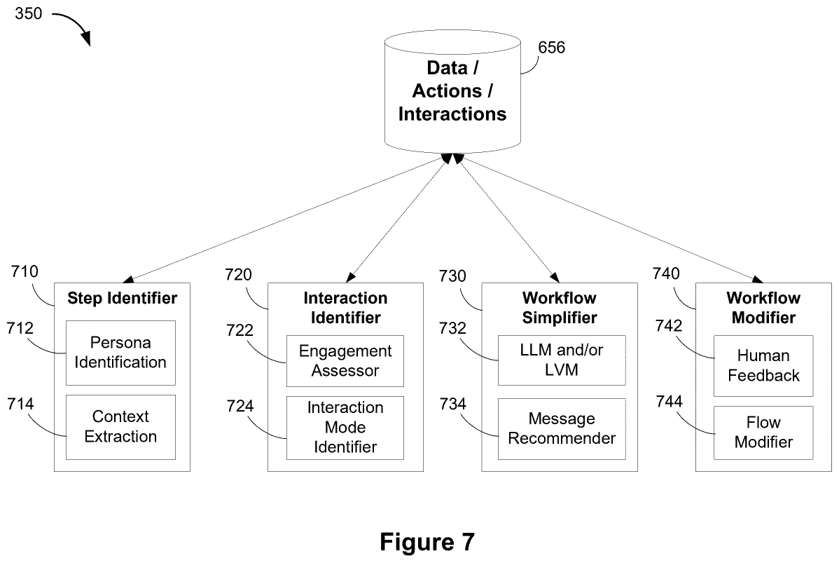

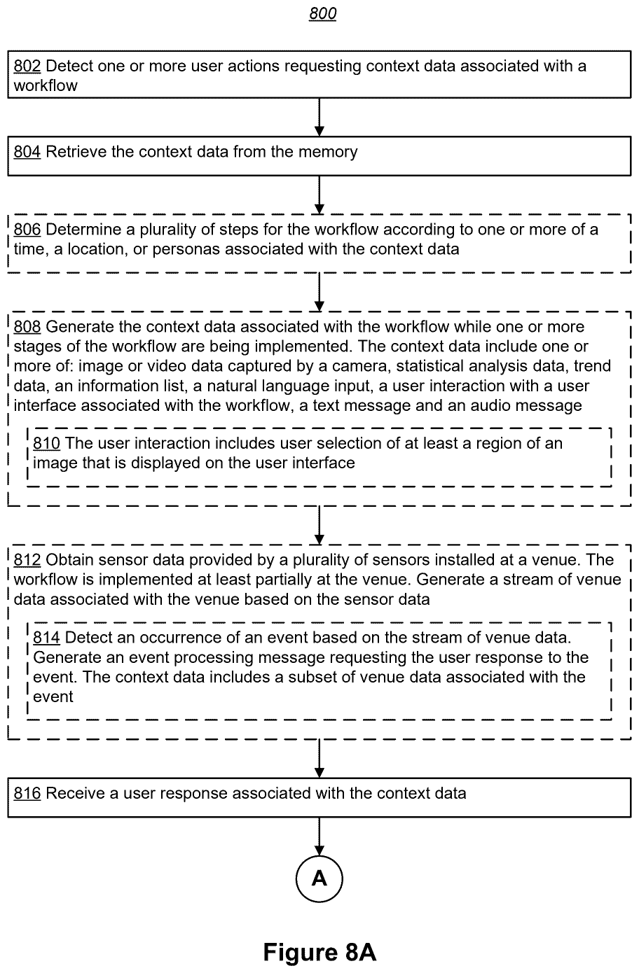

In some embodiments, the data processing module 328 includes a workflow control module 350, which is described with reference to FIG. 7.

Although many aspects of the present technology are described from the perspective of a computer system as a whole, the corresponding actions performed by the client device 240 and/or the server system 120 would be apparent to those of skill in the art. The server-side module 206 and the client-side module 202 are implemented at the server 120 and the client device 240, respectively. Each of the other modules 314-328 may be implemented in any of a server 120, a client device 240 (e.g., computer device 118, 130, or 134 in FIG. 1), a smart device 280 (e.g., devices 102-114 in FIG. 1), a storage 116, or a combination thereof.

Each of the above identified elements may be stored in one or more of the previously mentioned memory devices, and corresponds to a set of instructions for performing a function described above. The above identified modules or programs (e.g., sets of instructions) need not be implemented as separate software programs, procedures, modules, or data structures, and thus various subsets of these modules may be combined or otherwise rearranged in various implementations. In some implementations, the memory 306 stores a subset of the modules and data structures identified above. In some implementations, the memory 306 stores additional modules and data structures not described above.

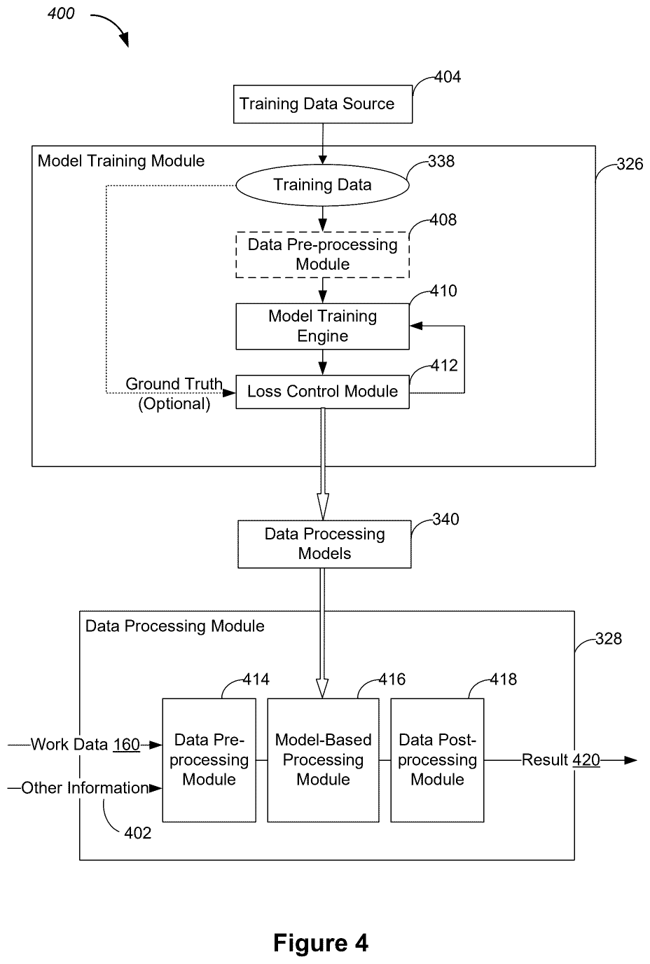

FIG. 4 is a block diagram of a machine learning system 400 for training and applying data processing models 340 using machine learning, in accordance with some embodiments. The machine learning system 400 includes a model training module 326 establishing one or more data processing models 340 and a data processing module 328 for processing data collected by smart devices 280 (e.g., cameras 110) using the data processing model 340. In some embodiments, both the model training module 326 (e.g., the model training module 326 in FIG. 3) and the data processing module 328 are located in the server 120, while a training data source 404 provides training data 338 to the server 120. In some embodiments, the training data source 404 is the data obtained from the smart devices 280, from another server 120, from storage 106, or from a client device. Alternatively, in some embodiments, the model training module 326 (e.g., the model training module 326 in FIG. 3) is located at a server 120, and the data processing module 328 is located in a smart device 280 or a client device 240. The server 120 trains the data processing models 328 and provides the trained models 340 to a smart device 280 or a client device 240 to process real-time work data 160 captured by the smart device 280.

In some embodiments, the training data 338 provided by the training data source 404 includes a standard dataset (e.g., a set of work site images) widely used by engineers in an associated industry to train data processing models 340. In some embodiments, the training data 338 includes work data 160 and/or additional work site information, which is collected from one or more smart devices that will apply the data processing models 340 or collected from distinct smart devices that will not apply the data processing models 340. Further, in some embodiments, a subset of the training data 338 is modified to augment the training data 338. The subset of modified training data is used in place of or jointly with the subset of training data 338 to train the data processing models 340.

In some embodiments, the model training module 326 includes a model training engine 410, and a loss control module 412. Each data processing model 340 is trained by the model training engine 410 to process corresponding work data 160.

Specifically, the model training engine 410 receives the training data 338 corresponding to a data processing model 340 to be trained, and processes the training data to build the data processing model 340. In some embodiments, during this process, the loss control module 412 monitors a loss function comparing the output associated with the respective training data item to a ground truth of the respective training data item. In these embodiments, the model training engine 410 modifies the data processing models 340 to reduce the loss, until the loss function satisfies a loss criteria (e.g., a comparison result of the loss function is minimized or reduced below a loss threshold). The data processing models 340 are thereby trained and provided to the data processing module 328 to process work data 160.

In some embodiments, the model training module 326 further includes a data pre-processing module 408 configured to pre-process the training data 338 before the training data 338 is used by the model training engine 410 to train a data processing model 340. For example, an image pre-processing module 408 is configured to format images in the training data 338 into a predefined image format. For example, the preprocessing module 408 may normalize the images to a fixed size, resolution, or contrast level. In another example, an image pre-processing module 408 extracts a region of interest (ROI) corresponding to a target area or object in each image or separates content of the target area or object into a distinct image.

In some embodiments, the model training module 326 uses supervised learning in which the training data 338 is labelled and includes a desired output for each training data item (also called the ground truth in some situations). In some embodiments, the desirable output is labelled manually by people or labelled automatically by the model training model 326 before training. In some embodiments, the model training module 326 uses unsupervised learning in which the training data 338 is not labelled. The model training module 326 is configured to identify previously undetected patterns in the training data 338 without pre-existing labels and with little or no human supervision. Additionally, in some embodiments, the model training module 326 uses partially supervised learning in which the training data is partially labelled.

In some embodiments, the data processing module 328 includes a data pre-processing module 414, a model-based processing module 416, and a data post-processing module 418. The data pre-processing modules 414 pre-processes work data 160 based on the type of the work data 160. In some embodiments, functions of the data pre-processing modules 414 are consistent with those of the pre-processing module 408, and convert the work data 160 into a predefined data format that is suitable for the inputs of the model-based processing module 416. The model-based processing module 416 applies the trained data processing model 340 provided by the model training module 326 to process the pre-processed work data 160. In some embodiments, the model-based processing module 416 also monitors an error indicator to determine whether the work data 160 has been properly processed in the data processing model 340. In some embodiments, the processed work data is further processed by the data post-processing module 418 to create a preferred format or to provide additional work information, associated with the smart work environment 100, which can be derived from the processed work data.

In some embodiments, work data 160 is supplemented with other information 402 (e.g., additional work site information, which is collected from one or more smart devices that will apply the data processing models 340 or collected from distinct smart devices that will not apply the data processing models 340). In some embodiments, the data processing module 328 uses the processed work data (e.g., result 420) to at least partially autonomously control an equipment or tool (e.g., forklift 126 in FIG. 1) that operates in the smart work environment 100. For example, the processed work data includes control instructions that are used by a control system (manned or unmanned) to drive the forklift 126. In some embodiments, the processed work data (e.g., result 420) is applied to at least partially autonomously control a robot operating on a vehicle assembly line or in an electronics manufacturing facility.

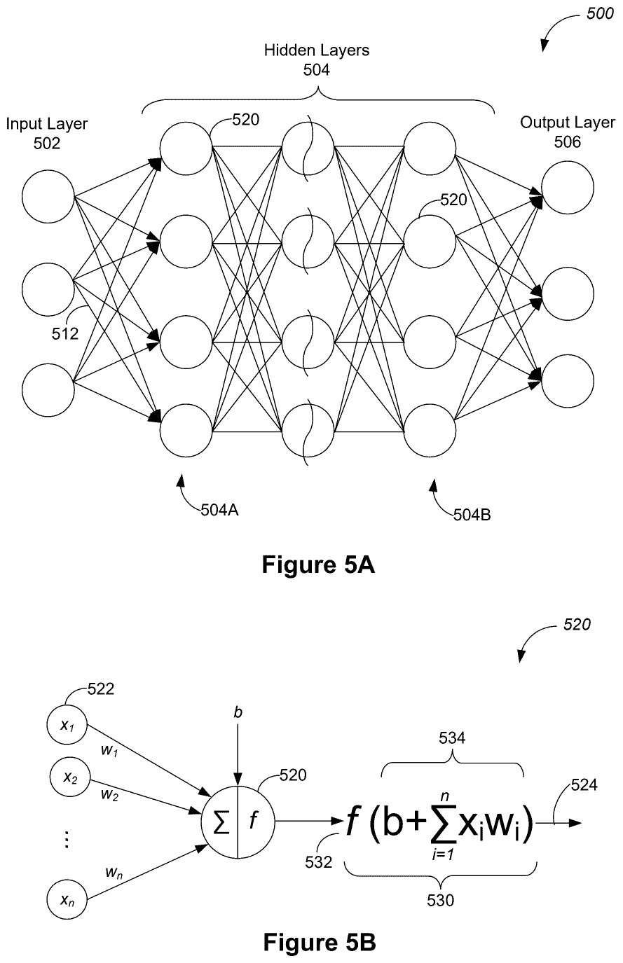

FIG. 5A is a structural diagram of an example neural network 500 applied to process work data in a data processing model 340, in accordance with some embodiments, and FIG. 5B is an example node 520 in the neural network 500, in accordance with some embodiments. It should be noted that this description is used as an example only, and other types or configurations may be used to implement the embodiments described herein. The data processing model 340 is established based on the neural network 500. A corresponding model-based processing module 416 applies the data processing model 340 including the neural network 500 to process work data 160 that has been converted to a predefined data format. The neural network 500 includes a collection of nodes 520 that are connected by links 512. Each node 520 receives one or more node inputs 522 and applies a propagation function 530 to generate a node output 524 from the one or more node inputs. As the node output 524 is provided via one or more links 512 to one or more other nodes 520, a weight w associated with each link 512 is applied to the node output 524. Likewise, the one or more node inputs 522 are combined based on corresponding weights w₁, w₂, w₃, and w₄ according to the propagation function 530. In an example, the propagation function 530 is computed by applying a non-linear activation function 532 to a linear weighted combination 534 of the one or more node inputs 522.

The collection of nodes 520 is organized into layers in the neural network 500. In general, the layers include an input layer 502 for receiving inputs, an output layer 506 for providing outputs, and one or more hidden layers 504 (e.g., layers 504A and 504B) between the input layer 502 and the output layer 506. A deep neural network has more than one hidden layer 504 between the input layer 502 and the output layer 506. In the neural network 500, each layer is only connected with its immediately preceding and/or immediately following layer. In some embodiments, a layer is a “fully connected” layer because each node in the layer is connected to every node in its immediately following layer. In some embodiments, a hidden layer 504 includes two or more nodes that are connected to the same node in its immediately following layer for down sampling or pooling the two or more nodes. In particular, max pooling uses a maximum value of the two or more nodes in the layer for generating the node of the immediately following layer.

In some embodiments, a convolutional neural network (CNN) is applied in a data processing model 340 to process work data (e.g., video and image data captured by cameras 110). The CNN employs convolution operations and belongs to a class of deep neural networks. The hidden layers 504 of the CNN include convolutional layers. Each node in a convolutional layer receives inputs from a receptive area associated with a previous layer (e.g., nine nodes). Each convolution layer uses a kernel to combine pixels in a respective area to generate outputs. For example, the kernel may be to a 3×3 matrix including weights applied to combine the pixels in the respective area surrounding each pixel. Video or image data is pre-processed to a predefined video/image format corresponding to the inputs of the CNN. In some embodiments, the pre-processed video or image data is abstracted by the CNN layers to form a respective feature map. In this way, video and image data can be processed by the CNN for video and image recognition or object detection.

In some embodiments, a recurrent neural network (RNN) is applied in the data processing model 340 to process work data 160. Nodes in successive layers of the RNN follow a temporal sequence, such that the RNN exhibits a temporal dynamic behavior. In an example, each node 520 of the RNN has a time-varying real-valued activation. It is noted that in some embodiments, two or more types of work data are processed by the data processing module 328, and two or more types of neural networks (e.g., both a CNN and an RNN) are applied in the same data processing model 340 to process the work data jointly.

The training process is a process for calibrating all of the weights wᵢ for each layer of the neural network 500 using training data 338 that is provided in the input layer 502. The training process typically includes two steps, forward propagation and backward propagation, which are repeated multiple times until a predefined convergence condition is satisfied. In the forward propagation, the set of weights for different layers are applied to the input data and intermediate results from the previous layers. In the backward propagation, a margin of error of the output (e.g., a loss function) is measured (e.g., by a loss control module 412), and the weights are adjusted accordingly to decrease the error. The activation function 532 can be linear, rectified linear, sigmoidal, hyperbolic tangent, or other types. In some embodiments, a network bias term b is added to the sum of the weighted outputs 534 from the previous layer before the activation function 532 is applied. The network bias b provides a perturbation that helps the neural network 500 avoid over fitting the training data. In some embodiments, the result of the training includes a network bias parameter b for each layer.

FIG. 6A is an exemplary workflow 600 associated with a warehousing application (e.g., an edge application, an AI application, or user application(s) 324), in accordance with some embodiments. In some embodiments, the warehousing application is executed by a computer system (e.g., computer system 300 in FIG. 3). In some embodiments, the warehousing application is implemented in conjunction with a physical environment, such as a warehouse environment, that includes one or more forklifts 126 that load and unload boxes 604 in the physical environment. The physical environment includes one or more cameras 110 that are configured to monitor, detect, and capture events and identify defects in the boxes 604.

In some embodiments, the computer system (e.g., warehousing application) senses, from data acquired by the one or more cameras 110, that a product (e.g., box 604) contains defects and sends an alert message 608 to a device associated with a human operator 610. The operator acknowledges the alert message 608 and sends a request to a quality assessment (QA) engineer 612 to assess the product defects. In some instances, the alert message 608 may include an error code associated with the defect, an image of a product having the defect, or both. In some instances, the QA engineer 612 reviews the image data, adds labels where applicable, and sends a request to an inspector 614 to file a claim form 616. The inspector 614 reviews the data, labels and any other relevant data, then fills out and submits the claim form 616.

In some embodiments, the workflow 600 includes multiple steps and handoffs to different parties and rely on humans, which may be prone to errors. In some instances, human interactions within the workflow, which can result in delays or interruptions in the AI application's process. Some embodiments of the present disclosure are directed to implementing AI and machine learning techniques to improve the efficiency of workflow 600, including automating portions of a workflow so as to save time and reduce errors. In some embodiments, each of the human operator 610, the QA engineer 612, and the inspector 614 is associated with a client device 240 (also called an edge device), and the client device 240 executes a client-side module 202 (FIG. 2) to provide inputs (e.g., claim form 616, requests) and obtain outputs (e.g., images, alert message 608) associated with the workflow 600.

FIG. 6B is an example table 650 describing a plurality of aspects (e.g., timeline 652, feature events 654, and context data 656 associated with events, actions, or interactions) of the workflow 600 sown in FIG. 6A, in accordance with some embodiments.

At a first time t₁, corresponding to a first feature event 654-1, the computer system detects a defect, e.g., while executing a user application. In the warehousing application of workflow 600, the cameras 110 can capture data indicating defects in a box 604. First context data 656-1 associated with the first feature event 654-1 can include sensor data (e.g., image and video data) acquired by cameras 110 and/or other sensors in the physical warehouse environment, timestamp and location information associated with the sensors data, object detection and identification data (e.g., identification of goods handled by the forklifts 126 from their barcodes), and defect detection and identification data (e.g., a defect type, such as whether the barcode is damaged or the product is damaged, and an identification of the product that is damaged). In some embodiments, the first context data 656-1 associated with actions or interactions include venue data (e.g., venue stream data) that is generated by sensors installed in the physical environment.

At a second time t₂, corresponding to a second feature event 654-2, the computer system creates an alert and sends the alert to an operator (e.g., human operator 610) to notify the operator of the defect. In some embodiments, the computer system sends the alert to a user interface so that the operator 610 can engage with the alert. In some embodiments, the user interface is displayed on a mobile device (e.g., device 118 or 130) of the operator 610. In some embodiments, the user interface is part of the physical environment (e.g., warehouse) where a screen that can support interactions is installed In some embodiments, second context data 656-2 associated with the second feature event 654-2 includes content of the alert that is created (e.g., description of the defect, or a time at which the defect occurred or was discovered), recipients of the alert and their device types, a timestamp at which the alert was transmitted, and a timestamp at which the alert was read by the operator.

At a third time t₃, corresponding to a third feature event 656-3, the operator 610 reviews one or more of the alerts triaging them. Third context data 656-3 associated with the third feature event 654-3 include interaction data. In some embodiments, the interaction data includes data from interactions between the operator 610 and the device, such as user gazing at or clicking on the user interface. In some embodiments, the interaction data includes data from interactions between the operator and the actual content. In some instances, if the operator agrees on some of the defect assessments that they are defects, the operator signs off on those. In some instances, the operator may add some notes about the defects. In some embodiments, the operator-data interactions include alerts that operator skips or bypasses during their review. For example, the operator 610 might start by querying all the alerts, look through them, and review only particular ones. In some embodiments, the operator 610 decides on the next steps. In some embodiments, the operator-data interactions include an amount of time spent by the operator reviewing a respective alert. In some embodiments, the third context data 656-3 include additional notes, annotations, and/or follow-up actions taken by the operator (e.g., scan barcode, add metadata) in response to reviewing the alert. For example, the operator can scan the barcode of the item, noting its physical location, or other such metadata to be added to this item. In some embodiments, once this is done, the data will be escalated by sending a message to a QA engineer 612. In some instances, the operator may dismiss some other flagged items because the defect is not problematic or there was no defect.

At a fourth time t₄, corresponding to a fourth feature event 654-4, the QA engineer 612 receives a message from the system that includes a description (e.g., text and/or images) of the defects. In some embodiments, fourth context data 656-4 associated with the fourth feature event 654-4 include data from the content of the reports that the QA engineer is tasked to review. In some embodiments, the fourth context data 656-4 associated with the event 654-4 include interaction data from (i) interactions between the QA engineer and the device, and (ii) interactions between the QA engineer and the content presented to the QA engineer. In some embodiments, the fourth context data 656-4 associated with the fourth feature event 654-4 include follow up actions taken by the QA engineer. For example, the QA engineer may review the images, ask for more images, or even visit the actual product for further assessment. At some point, the QA engineer 612 signs off on the defects agreeing that these are problematic and reviews other defects that may require further assessment. The QA engineer 612 can also input information to indicate their decisions.

At a fifth time t₅, corresponding to a fifth feature event 654-5, the decisions from the QA engineer 612 are routed to an inspector 614 to take additional actions. In some embodiments, fifth context data 656-5 associated with the fifth feature event 654-5 include content in the requests received by the inspector 614 and the data included in the requests in requests that lead to claim forms being submitted or not submitted by the inspector 614. For example, in some instances, the inspector 614 may select a subset of these requests to route to an insurance company to file a claim. As part of the routing process, the inspector 614 may complete a form to include data needed to file a claim, and submit the form to an insurance provider. In some embodiments, the fifth context data 656-5 associated with the fifth feature event 654-5 include content in the claim forms and notes, annotations, or follow-up actions taken by the inspector. For example, in some instances, the inspector 614 might set up weekly reminders to check in on the status of these claims or answer questions that were not filled correctly.

FIG. 6C is a flow diagram of an example workflow management process 680 for managing a workflow 600, in accordance with some embodiments. In some implementations, the workflow 600 is implemented in a smart work environment 100 including a plurality of smart devices 280 and a plurality of client devices 240. Context data 656 may be continuously collected by the smart devices 280 and the client devices 240 to record feature events 654, user actions, and user device interactions occurring in the smart work environment 100. Further, in some embodiments, a user (e.g., engineer 612) interacts with a user interface of a user application (e.g., a warehousing application) to review a set of context data 656 selectively, and generates a user response 682 to the set of context data 656. It may be assumed that the set of context data 656 is associated with, and leads to, the user response 682. A context processing model 684 is applied to process the context data 656 to generate model output data 686, which is compared with the user response 682. A workflow controlling instruction 688 may be generated based on a difference of the user response 682 and the model output data 686.

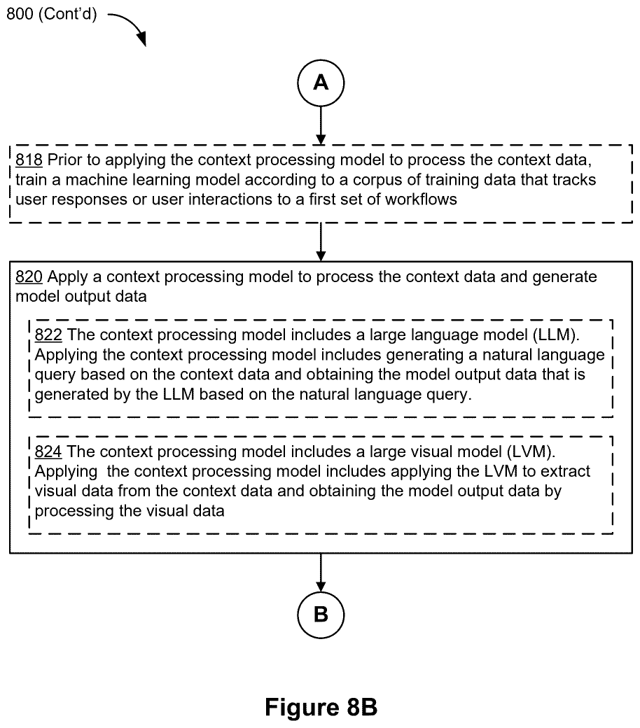

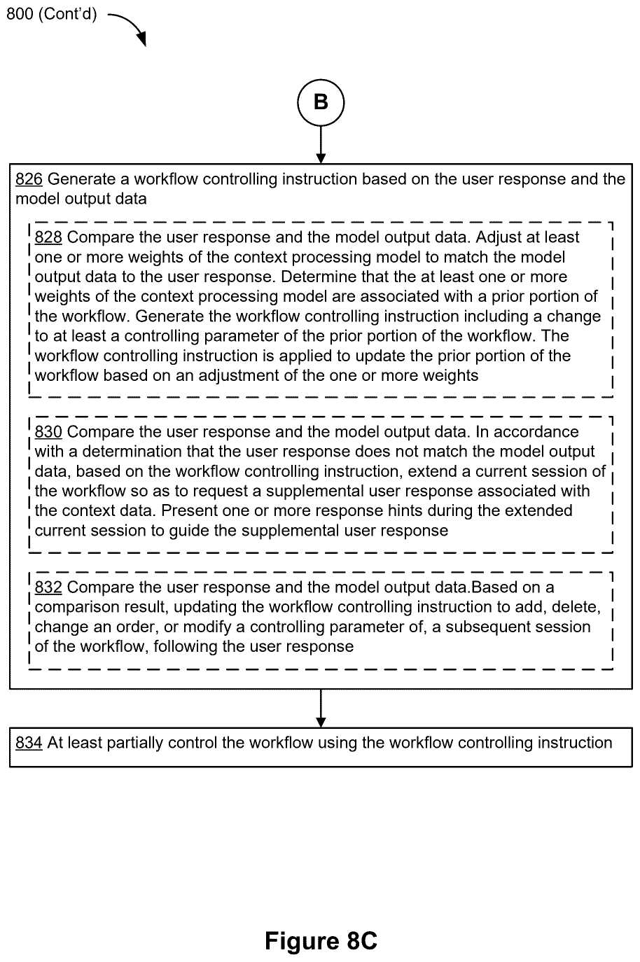

In some embodiments, the workflow controlling instruction 688 improves performance of the workflow 600 by modifying one or more of: one or more previous operations of a previous session 690, one or more current operations of a current session 692, or one or more subsequent operations of a subsequent session 694. For example, the user response 682 may match the model output data 686, and additional review by the inspector 616 may be skipped entirely. It is known to people having ordinary skill in the art that FIG. 6C merely focuses the current session 692 on the engineer 612 as an example and that the current session 692 may correspond to any user (e.g. operation 610, inspector 614) involved in the workflow 600. More details on the workflow management processor 680 are explained below with reference to FIG. 8.

FIG. 7 is a block diagram of an example workflow control module 350 for controlling a workflow (e.g., workflow 600 in FIG. 6A) in a user application, in accordance with some embodiments. In some embodiments, a workflow control module 350 includes an AI or machine learning (ML) module that learns from the context data 656 collected from different sessions or instances of the workflow in association with actions or interactions, to improve an organizational objective. For instance, in the example of the workflow 600, the organizational objective may be to improve the probability of getting an insurance claim approved.

In some embodiments, the workflow control module 350 includes a step identifier 710 for identifying steps in a workflow. In some embodiments, step identifier 710 detects steps of a workflow automatically using time, location, and personas. In some embodiments, the step identifier 710 includes a persona identification sub-module 712 for identifying personas associated with the workflow. In some embodiments, the step identifier 710 includes a context extraction sub-module 714 for extracting context data 656 from various steps of a workflow. In some embodiments, the context data 656 includes previous data associated with the workflow, previous user interactions, engagements, or user actions associated with the workflow, and previous decisions associated with the workflow. In some embodiments, the context data 656 include image data, video data, or other sensor data captured by one or more sensors (e.g., smart devices 102-114 in FIG. 1) associated with the workflow. In some embodiments, the context data 656 includes statistical analysis data, trend data, an information list, a natural language input, a user interaction with a user interface associated with the workflow, a text message or an audio message.

In some embodiments, the workflow control module 350 includes an interaction identifier 720 for observing the human actions or interactions for each step. For example, in some embodiments, the human actions or interactions include gaze tracking, click tracking, text entered, or any other engagement and input controlled by the user, as described with reference to FIG. 6B.

In some embodiments, the interaction identifier 720 includes an engagement assessor sub-module 722 that assesses the level of engagement of the user with the content or the device. In some embodiments, the engagement assessor sub-module 722 correlates content with user engagement. For example, in some embodiments, the engagement assessor sub-module 722 is configured to determine what sort of content would cause a user to skip an alert or pay attention to an alert.

In some embodiments, the interaction identifier 720 includes an interaction mode identifier sub-module 724 that is configured to determine user interaction modes and interaction levels with the content (e.g., quality of engagement, avoidance, participation, contribution, follow-up actions).

In some embodiments, the location and context of the user supports identification of the user persona. In some embodiments, the interaction mode identifier sub-module 724 groups the data received from all operators as one persona and similarly for both the supervisor and quality control person. In some embodiments, the interaction mode identifier sub-module 724 determines (or differentiates) the actions from the content. By different techniques can be applied to automate the type of interaction (e.g., action versus content generation).

In some embodiments, the workflow control module 350 includes a workflow simplifier 730 for automating one or more portions of the workflow using the relevant technologies. For example, in some embodiments, the workflow simplifier 730 includes large language models (LLMs) or large visual models (LVMs) 732. For filling forms and adding content, an LLM can be fine-tuned using data entered by the users. In some embodiments, the LLM uses the data presented on the screen as tokens or prompts, and generates what needs to be on the form. In some embodiments, the LLM initially pre-fills the form for the human and allows them to edit or approve. In some embodiments, the LVM can be applied to extract visual data from the context data 656. In some embodiments, as the computer system learns and no human inputs are detected for modifications, these steps can be fully automated.

In some embodiments, a workflow includes a user task (e.g., submitting an defect analysis report prepared based on work data 160). The workflow includes an entry point (e.g., an instruction to prepare the report) and an exit point (e.g., a submission of the report) associated with the user task. After the entry point, a user may interact with a client device 240 associated with the user to search for, and review, context data (e.g., the work data 160) associated with an error to be covered in the defect analysis report. Based on user interactions with the client device 240, the content data reviewed by the user may be tracked and provided to the LLM automatically, e.g., during an LLM training process. In some implementations, when the LLM is applied during data inference, the computer system may not need to track the user interactions. The computer system may automatically predict and extract the context data based on the user task, and generate an output (e.g., a defect analysis report) based on the context data to fulfill the user task, thereby eliminating a need for user interactions and simplifying the user task involved in the workflow. In some situations, the computer system may even extract supplemental data associated with the context data associated with the error to be covered in the defect analysis report beyond the context data, and produce a defect analysis report that has a better quality than a report prepared by the user.

In some embodiments, the workflow simplifier 730 includes a message recommender sub-module 734 for creating and routing messages. In some embodiments, the message recommender sub-module 734 applies different AI techniques to create and route messages. For example, these techniques can use the forms, the context data 656 and additional data from the system as inputs to determine what messages to create, where to route the messages, and how to store the messages.

In some embodiments, the workflow control module 350 includes a workflow modifier 740 that is configured to modify the workflow so as to improve time and efficiency. The workflow modifier 740 includes a human feedback sub-module 742 and a flow modifier sub-module 744, in accordance with some embodiments. In some embodiments, the human feedback sub-module 742 is configured to determine whether the workflow for certain mission critical applications and use cases may still require human approval. In some embodiments, for many applications, the human approval phase can be eliminated (e.g., the modified by the flow modifier sub-module 744), thus making these processes more efficient.

FIGS. 8A to 8C provide a flowchart of an example process 800 for controlling a workflow, in accordance with some embodiments. The method 800 is performed at a computer system (e.g., computer system 300). An example workflow includes the workflow 600 shown in FIG. 6A. User responses and corresponding model outputs are tracked and compared in the process 800, thereby dynamically controlling the workflow

The computer system includes one or more processors (e.g., processor(s) 302) and memory (e.g., memory 306). In some embodiments, the one or more processors comprise a plurality of processors corresponding to a plurality of processor types, such as a central processing unit (CPU), a graphics processing unit (GPU, including an integrated GPU or a general purpose GPU (GPGPU), or a tensor processing unit (TPU). In some embodiments, the memory stores one or more programs or instructions configured for execution by the one or more processors. In some embodiments, the operations shown in FIGS. 1, 2, 4, 5A, 5B, 6A-6C, and 7 correspond to instructions stored in the memory or other non-transitory computer-readable storage medium. The computer-readable storage medium may include a magnetic or optical disk storage device, solid state storage devices such as Flash memory, or other non-volatile memory device or devices. In some embodiments, the instructions stored on the computer-readable storage medium include one or more of: source code, assembly language code, object code, or other instruction format that is interpreted by one or more processors. Some operations in the method 800 may be combined. The order of some operations may be changed.

Referring to FIG. 8A, the computer system detects (operation 802) one or more user actions requesting context data (e.g., context data 656 in FIGS. 6B and 6C) associated with a workflow. In some embodiments, a user request is implicitly made, when a user (e.g., operator 610, engineer 612, and inspector 614 in FIG. 6C) reviews the context data during the course of fulfilling a task (e.g., writing a defect assessment review, preparing a claim report). In some embodiments, the workflow includes a series of sessions and each session includes one or more tasks, stages, or steps. In some embodiments, the workflow includes multiple sessions (e.g., instances), where each session (e.g., sessions 690, 692, and 694 in FIG. 6C) corresponds to execution of a respective portion of the workflow. In some embodiments, context data includes previous data associated with the workflow, previous user interactions, engagements, or user actions associated with the workflow, and previous decisions associated with the workflow. In some embodiments, the workflow includes multiple steps that are performed by multiple users. In some embodiments, the workflow includes handoffs across different users and/or different devices.

The computer system retrieves (operation 804) the context data from the memory (e.g., based on user history or a workflow history). In an example, during or after a workflow of assembling a vehicle, a user is requested to implement a user task of preparing a defect analysis report about a certain type of vehicle defects created by a robotic arm during the workflow. A user may click on different images recorded on a vehicle assembly line and associated documents including engineering data (e.g., voltage data, power data) created for the robotic arm's operations. The images and documents are part of context data associated with the workflow, and the user clicks request the context data to allow the user to prepare the defect analysis report. Such context data can be tracked and used by a context processing model to generate model output data separately from the defect analysis report provided by the user.

In some embodiments, the computer system determines (operation 806) (e.g., automatically, without user intervention) a plurality of steps for the workflow according to one or more of a time, a location, or user accounts associated with the context data.

In some embodiments, the computer system generates (operation 808) the context data associated with the workflow while one or more stages, operations, or sessions of the workflow are being implemented. The context data include one or more of: image or video data captured by a camera, statistical analysis data, trend data, an information list, a natural language input, a user interaction with a user interface associated with the workflow, a text message and an audio message. In some embodiments, the context data comprises data that a user sees on a user interface of a device associated with the workflow. In some embodiments, the context data comprises user interaction with the data. In some embodiments, the context data comprises historical data or the user's previous interactions with the data.

In some embodiments, the user interaction includes (operation 810) user selection of at least a region of an image that is displayed on the user interface.

In some embodiments, the computer system obtains (operation 812) sensor data provided by a plurality of sensors (e.g., smart devices 102-114 in FIG. 1) installed at a venue (e.g., a structure 150 of a warehouse in FIG. 1). The workflow is implemented at least partially at the venue. The computer system generates a stream of venue data (e.g., work data 160 in FIGS. 1 and 2) associated with the venue based on the sensor data.

In some embodiments, the computer system detects (operation 814) an occurrence of an event (e.g., a predefined event, a signature or feature event, or an event that is of significance) based on the stream of venue data. The computer system generates an event processing message requesting the user response to the event. The context data includes a subset of venue data associated with the event.

The computer system receives (operation 816) a user response (e.g., user response 682 in FIG. 6C) associated with the context data. For example, in some embodiments, the user response comprises a user action, such as a command to submit a document or move a defective box. In some embodiments, the user action comprises a user interaction with an electronic device associated with the user, responsive to the context data for the workflow. In some embodiments, the user response can be used for retraining and/or refining a model that tracks user responses or user interactions to a first set of workflows.

Referring to FIG. 8B, in some embodiments, prior to applying a context processing model (e.g., model 684 in FIG. 6C) to process the context data, the computer system trains (operation 818) the context processing model according to a corpus of training data that includes historical user responses or user interactions to a first set of workflows. In some embodiments, the training data can include gaze tracking, click tracking, text entered, and any other engagement and input controlled by the user.

The computer system applies (operation 820) a context processing model (e.g., model 684 in FIG. 6C) to process the context data and generate model output data (e.g., data 686 in FIG. 6C).

In some embodiments, the context processing model includes (operation 822) a large language model (LLM). Applying the context processing model includes generating a natural language query based on the context data and obtaining the model output data that is generated by the LLM based on the natural language query. For example, referring to FIG. 6C, the user response 682 includes a first claim report prepared by an inspector 614, and the model output data 686 includes a second claim report generated by the LLM in response to the natural language query.

In some embodiments, the context processing model includes (operation 824) a large visual model (LVM). Applying the context processing model further includes applying the LVM to extract visual data from the context data and obtaining the model output data by processing the visual data.

With continued reference to FIG. 8C, the computer system generates (operation 826) a workflow controlling instruction (e.g., instruction 688 in FIG. 6C) based on the user response and the model output data.

In some embodiments, generating the workflow controlling instruction includes comparing (operation 828) the user response and the model output data; adjusting at least one or more weights of the context processing model to match the model output data to the user response; determining that the at least one or more weights of the context processing model are associated with a prior portion (e.g., prior stage or a prior step) of the workflow; and generating the workflow controlling instruction including a change to at least a controlling parameter of the prior portion of the workflow. For example, a workflow associated with a warehousing application can include one or more cameras monitoring the events in a warehouse. Changing a controlling parameter can include changing one or more acquisition parameters of the camera, such as a field of view, an exposure time, or adding another camera view. The workflow controlling instruction is applied to update the prior portion of the workflow based on an adjustment of the one or more weights. For example, in some embodiments, the computer system increases a weight when the prior stage of the workflow is determined to be more important, or vice versa. For example, in accordance with a determination that a weight has dropped below a certain level (e.g., is less than 0.01), the computer device may identify a previous operation (e.g., image capturing by a certain camera) associated with the weight and disable the previous operation.

In some embodiments, generating the workflow controlling instruction includes comparing (operation 830) the user response and the model output data. In some embodiments, in accordance with a determination by the computer system that the user response does not match the model output data, based on the workflow controlling instruction, the computer system extends a current session of the workflow (e.g., session 692 in FIG. 6C), or a current stage of the workflow, so as to request a supplemental user response associated with the context data. For example, the user may be requested to review, and resubmit, a claim report due to an inconsistency with the model output data. The computer system presents one or more response hints during the extended current session (or extended stage) to guide the supplemental user response (e.g., so as to obtain more data).

In some embodiments, generating the workflow controlling instruction includes comparing (operation 832) the user response and the model output data. The computer system, based on a comparison result, updates the workflow controlling instruction to add, delete, change an order, or modify a controlling parameter of, a subsequent session of the workflow, following the user response. For example, in accordance with a determination that the user response and the model output data are substantially consistent, a subsequent session of inspector review may be skipped (i.e., deleted), thereby conserving computational, storage, and communication resources needed to enable the inspector review.

In some embodiments, an large language model (LLM) can be fine-tuned using data entered by the users and using the data presented on the screen as tokens or prompts. The LLM is configured to generate content that needs to be filled out on the form. In some embodiments, the LLM can be configured to pre-fill the form for the user, and the user is allowed to edit or approve the pre-filled content. As the system improves to the extent that no user modification to the form is required, this step can be fully automated thus deleting the user approval process. In this example, the workflow is also modified because the step of sending the form for approval can be eliminated.

The computer system at least partially controls (operation 834) the workflow using the workflow controlling instruction.

Turning on to some example embodiments:
(A1) In accordance with some embodiments, a method for controlling workflows is implemented at a computer system having one or more processors and memory. The method includes detecting one or more user actions requesting context data associated with a workflow. The methos includes retrieving the context data from the memory and receiving a user response associated with the context data. The method includes applying a context processing model to process the context data and generate model output data. The method includes generating a workflow controlling instruction based on the user response and the model output data. The method also includes at least partially controlling the workflow using the workflow controlling instruction.
(A2) In some embodiments of A1, generating the workflow controlling instruction includes (i) comparing the user response and the model output data; (ii) adjusting at least one or more weights of the context processing model to match the model output data to the user response; (iii) determining that the at least one or more weights of the context processing model are associated with a prior portion of the workflow; and (iv) generating the workflow controlling instruction including a change to at least a controlling parameter of the prior portion of the workflow, wherein the workflow controlling instruction is applied to update the prior portion of the workflow based on an adjustment of the one or more weights
(A3) In some embodiments of A1 or A2, generating the workflow controlling instruction includes (i) comparing the user response and the model output data; and (ii) in accordance with a determination that the user response does not match the model output data, based on the workflow controlling instruction, extending a current session (of a current step) of the workflow so as to request a supplemental user response associated with the context data, wherein one or more response hints are presented during the extended current session to guide the supplemental user response.
(A4) In some embodiments of any of A1-A3, generating the workflow controlling instruction further comprises (i) comparing the user response and the model output data; and (ii) based on a comparison result, updating the workflow controlling instruction to add, delete, change an order, or modify a controlling parameter of, a subsequent session of the workflow, following the user response.
(A5) In some embodiments of any of A1-A4, the method further includes generating the context data associated with the workflow, while one or more stages of the workflow are being implemented. The context data include one or more of: image or video data captured by a camera, statistical analysis data, trend data, an information list, a natural language input, a user interaction with a user interface associated with the workflow, a text message and an audio message.
(A6) In some embodiments of A5, the user interaction includes user selection of at least a region of an image that is displayed on the user interface.
(A7) In some embodiments of any of A1-A6, the method includes (i) obtaining sensor data provided by a plurality of sensors installed at a venue, wherein the workflow is implemented at least partially at the venue; and (ii) generating a stream of venue data associated with the venue based on the sensor data.
(A8) In some embodiments of A7, the method includes detecting an occurrence of an event based on the stream of venue data; and generating an event processing message requesting the user response to the event, wherein the context data includes a subset of venue data associated with the event.
(A9) In some embodiments of any of A1-A8, the context processing model includes a large language model (LLM). Applying the context processing model further includes: (i) generating a natural language query based on the context data; and (ii) obtaining the model output data that is generated by the LLM based on the natural language query.
(A10) In some embodiments of any of A1-A9, the context processing model includes a large visual model (LVM). Applying the context processing model further includes: (i) applying the LVM to extract visual data from the context data; and (ii) obtaining the model output data by processing the visual data.
(A11) In some embodiments of any of A1-A10, the method includes determining a plurality of steps for the workflow according to one or more of a time, a location, or personas associated with the context data.
(A12) In some embodiments of any of A1-A11, the method includes, prior to applying the context processing model to process the context data, training the context processing model according to a corpus of training data that tracks user responses or user interactions to a first set of workflows.
(B1) In accordance with some embodiments, a computer system includes one or more processors and memory. The memory stores one or more programs for execution by the one or more processors. The one or more programs include instructions for performing the method of any of A1-A12.
(C1) In accordance with some embodiments, a non-transitory computer-readable storage medium stores one or more programs for execution by one or more processors. The one or more programs include instructions for performing the method of any of A1-A12.

As used herein, the term “plurality” denotes two or more. For example, a plurality of components indicates two or more components. The term “determining” encompasses a wide variety of actions and, therefore, “determining” can include calculating, computing, processing, deriving, investigating, looking up (e.g., looking up in a table, a database or another data structure), ascertaining and the like. Also, “determining” can include receiving (e.g., receiving information), accessing (e.g., accessing data in a memory) and the like. Also, “determining” can include resolving, selecting, choosing, establishing and the like.

As used herein, the phrase “based on” does not mean “based only on,” unless expressly specified otherwise. In other words, the phrase “based on” describes both “based only on” and “based at least on.”

As used herein, the term “exemplary” means “serving as an example, instance, or illustration,” and does not necessarily indicate any preference or superiority of the example over any other configurations or implementations.

As used herein, the term “and/or” encompasses any combination of listed elements. For example, “A, B, and/or C” includes the following sets of elements: A only, B only, C only, A and B without C, A and C without B, B and C without A, and a combination of all three elements, A, B, and C.

The terminology used in the description of the invention herein is for the purpose of describing particular implementations only and is not intended to be limiting of the invention. As used in the description of the invention and the appended claims, the singular forms “a,” “an,” and “the” are intended to include the plural forms as well, unless the context clearly indicates otherwise. It will also be understood that the term “and/or” as used herein refers to and encompasses any and all possible combinations of one or more of the associated listed items. It will be further understood that the terms “comprises” and/or “comprising,” when used in this specification, specify the presence of stated features, steps, operations, elements, and/or components, but do not preclude the presence or addition of one or more other features, steps, operations, elements, components, and/or groups thereof.

The foregoing description, for purpose of explanation, has been described with reference to specific implementations. However, the illustrative discussions above are not intended to be exhaustive or to limit the invention to the precise forms disclosed. Many modifications and variations are possible in view of the above teachings. The implementations were chosen and described in order to best explain the principles of the invention and its practical applications, to thereby enable others skilled in the art to best utilize the invention and various implementations with various modifications as are suited to the particular use contemplated.

What is claimed is:

1. A method for controlling workflows, comprising:
at a computer system having one or more processors and memory:
detecting one or more user actions requesting context data associated with a workflow;
retrieving the context data from the memory;
receiving a user response associated with the context data;
applying a context processing model to process the context data and generate model output data;
generating a workflow controlling instruction based on the user response and the model output data; and
at least partially controlling the workflow using the workflow controlling instruction.

2. The method of claim 1, wherein generating the workflow controlling instruction further comprises:
comparing the user response and the model output data;
adjusting one or more weights of the context processing model to match the model output data to the user response;
determining that the one or more weights of the context processing model are associated with a prior portion of the workflow; and
generating the workflow controlling instruction including a change to at least a controlling parameter of the prior portion of the workflow, wherein the workflow controlling instruction is applied to update the prior portion of the workflow based on an adjustment of the one or more weights.

3. The method of claim 1, wherein generating the workflow controlling instruction further comprises:
comparing the user response and the model output data; and
in accordance with a determination that the user response does not match the model output data, based on the workflow controlling instruction, extending a current session of the workflow so as to request a supplemental user response associated with the context data, wherein one or more response hints are presented during the extended current session to guide the supplemental user response.

4. The method of claim 1 wherein generating the workflow controlling instruction further comprises:
comparing the user response and the model output data; and
based on a comparison result, updating the workflow controlling instruction to add, delete, change an order, or modify a controlling parameter of, a subsequent session of the workflow, following the user response.

5. The method of claim 1, further comprising:
generating the context data associated with the workflow, while one or more stages of the workflow are being implemented, wherein the context data include one or more of: image or video data captured by a camera, statistical analysis data, trend data, an information list, a natural language input, a user interaction with a user interface associated with the workflow, a text message and an audio message.

6. The method of claim 5, wherein the user interaction includes user selection of at least a region of an image that is displayed on the user interface.

7. The method of claim 1, further comprising:
obtaining sensor data provided by a plurality of sensors installed at a venue, wherein the workflow is implemented at least partially at the venue; and
generating a stream of venue data associated with the venue based on the sensor data.

8. The method of claim 7, further comprising:
detecting an occurrence of an event based on the stream of venue data; and
generating an event processing message requesting the user response to the event, wherein the context data includes a subset of venue data associated with the event.

9. The method of claim 1, wherein the context processing model includes a large language model (LLM), and applying the context processing model further comprises:
generating a natural language query based on the context data; and
obtaining the model output data that is generated by the LLM based on the natural language query.

10. The method of claim 1, wherein the context processing model includes a large visual model (LVM), and applying the context processing model further comprises:
applying the LVM to extract visual data from the context data; and
obtaining the model output data by processing the visual data.

11. The method of claim 1, further comprising:
determining a plurality of steps for the workflow according to one or more of a time, a location, or personas associated with the context data.

12. The method of claim 1, further comprising:
prior to applying the context processing model to process the context data, training the context processing model according to a corpus of training data that tracks user responses (or user interactions) to a first set of workflows.

13. A computer system, comprising:
one or more processors; and
memory storing one or more programs for execution by the one or more processors, the one or more programs further comprising instructions for:
detecting one or more user actions requesting context data associated with a workflow;
retrieving the context data from the memory;
receiving a user response associated with the context data;
applying a context processing model to process the context data and generate model output data;
generating a workflow controlling instruction based on the user response and the model output data; and
at least partially controlling the workflow using the workflow controlling instruction.

14. The computer system of claim 13, wherein the instructions for generating the workflow controlling instruction further include instructions for:
comparing the user response and the model output data;
adjusting at least one or more weights of the context processing model to match the model output data to the user response;
determining that the at least one or more weights of the context processing model are associated with a prior portion of the workflow; and
generating the workflow controlling instruction including a change to at least a controlling parameter of the prior portion of the workflow, wherein the workflow controlling instruction is applied to update the prior portion of the workflow based on an adjustment of the one or more weights.

15. The computer system of claim 13, wherein the instructions for generating the workflow controlling instruction further include instructions for:
comparing the user response and the model output data; and
in accordance with a determination that the user response does not match the model output data, based on the workflow controlling instruction, extending a current session (of a current step) of the workflow so as to request a supplemental user response associated with the context data, wherein one or more response hints are presented during the extended current session to guide the supplemental user response.

16. The computer system of claim 13, wherein the instructions for generating the workflow controlling instruction further include instructions for:
comparing the user response and the model output data; and
based on a comparison result, updating the workflow controlling instruction to add, delete, change an order, or modify a controlling parameter of, a subsequent session of the workflow, following the user response.

17. A non-transitory computer-readable storage medium, storing one or more programs for execution by one or more processors, the one or more programs further comprising instructions for:
detecting one or more user actions requesting context data associated with a workflow;
retrieving the context data from the memory;
receiving a user response associated with the context data;
applying a context processing model to process the context data and generate model output data;
generating a workflow controlling instruction based on the user response and the model output data; and
at least partially controlling the workflow using the workflow controlling instruction.

18. The non-transitory computer-readable storage medium of claim 17, the one or more programs further comprising instructions for:
obtaining sensor data provided by a plurality of sensors installed at a venue, wherein the workflow is implemented at least partially at the venue; and
generating a stream of venue data associated with the venue based on the sensor data.

19. The non-transitory computer-readable storage medium of claim 17, the one or more programs further comprising instructions for:
determining a plurality of steps for the workflow according to one or more of a time, a location, or personas associated with the context data.

20. The non-transitory computer-readable storage medium of claim 17, the one or more programs further comprising instructions for:
prior to applying the context processing model to process the context data, training the context processing model according to a corpus of training data that tracks user responses or user interactions to a first set of workflows.
